(19) United States
(12) Patent Application Publication
(10) Pub. No.: US 2026/0070324 A1
(43) Pub. Date: Mar. 12, 2026

(54) Method of Forming Graphic on Flexible Sheet Material

(71) Applicant: CHANCE LINE INDUSTRIAL CO., LTD., Siansi Township (TW)

(72) Inventor: Ming-Hsien YAO, Siansi Township (TW)

(21) Appl. No.: 18/883,359

(22) Filed: Sep. 12, 2024

(51) Int. Cl. B41F 16/00; B41F 16/02

(52) U.S. Cl. CPC B41F 16/0093; B41F 16/02

(57) ABSTRACT

The invention discloses a method of forming a graphic on a flexible sheet material. Firstly, printing a pattern on a heat transfer material; then preparing a covering film and attaching to the heat transfer material, cutting out a graphic from the heat transfer material and the covering film attached to each other, and then adhering the graphic onto a flexible sheet material by hot ironing. The invention discloses another method of forming a graphic on a flexible sheet material. Firstly, printing a pattern on a heat transfer material, cutting out a graphic from the heat transfer material, hot ironing the graphic onto a flexible sheet material; preparing a covering film and cutting out a graphic film from the covering film, and adhering the graphic film onto the graphic. The graphic and the pattern formed by the method of the invention are covered by the covering film, which is capable of maintaining an integrity of the graphic and maintaining colors of the pattern.

### FIELD OF THE INVENTION

The invention relates to a method of forming graphics, more particularly to a method of forming a graphic on a surface of a flexible sheet material.

### DESCRIPTION OF THE RELATED ART

Printable heat transfer vinyl is available on the DIY market for the public to purchase. Users can print on the heat transfer vinyl and cut out a graphic from the heat transfer vinyl, and then adhere the graphic onto clothes through heating. In this way, the clothes can have unique graphics and create a unique look that is different from others.

In order to increase people's desire to purchase, heat transfer vinyl manufacturers will produce a variety of heat transfer vinyls and display them in shopping malls for the public to choose from, such as heat transfer vinyls of various colors, backgrounds or textures.

However, producing various styles of heat transfer vinyls will cause many problems, such as: more styles and varieties of heat transfer vinyls require more inventory and inventory space, and some of the heat transfer vinyls will be unsaleable and unpopular, resulting in a cost burden for the manufacturers. In addition, the more styles of heat transfer vinyls produced, the less environmentally friendly to Earth.

In addition, for printable heat transfer vinyls on the DIY market, people use EPSON, HP and other household printers at home to print graphics with dye ink on the printable heat transfer vinyls, or use laser printers to print toner on the printable heat transfer vinyls. The ink or toner of such type of graphics formed by the heat transfer vinyls on the surfaces of clothes by hot ironing is loosely adhered on the fibers of the clothes, and the ink or toner is not resistant to washing in water. After two or three times of washing in water, the ink or toner on the graphics will fall off, diffuse or scatter, causing the graphics to be incomplete or damaged, and the colors will fade and become less vivid. After all, the main purpose of household printers is for printing on paper, not on clothing. When the graphics are incomplete and the colors are not vivid, people will be reluctant to continue wearing the clothes, and it is difficult to completely remove the graphics from the clothes. Eventually, people discard the clothes due to the damaged and inaesthetic graphics, resulting in waste.

### SUMMARY OF THE INVENTION

One object of the invention is to provide a method of forming a graphic on a flexible sheet material, the method is provided for consumers to make the graphic with a pattern by DIY, a product used to make the graphic is simple in style, capable of greatly reducing an inventory, and is environmentally friendly to Earth.

One object of the invention is to provide a method of forming a graphic on a flexible sheet material, the graphic has a pattern, the formed graphic and the pattern thereof are capable of withstanding washing in water, maintaining an integrity, and maintaining vivid colors.

A method of forming a graphic on a flexible sheet material provided by the invention, comprising following steps of:
step 1, preparing a printable heat transfer material, the heat transfer material having a printing layer and a heat adhesive layer, printing a pattern on the printing layer;
step 2, preparing a covering film, the covering film comprising a transparent or translucent surface film layer and a second adhesive layer, adhering the covering film onto the printing layer of the heat transfer material through the second adhesive layer to cover the pattern;
step 3, cutting out a graphic from the adhered heat transfer material and the covering film, discarding parts other than the graphic, the cut graphic comprising the printing layer, the heat adhesive layer, the surface film layer and the second adhesive layer overlappingly connected with one another; and
step 4, hot ironing the cut graphic onto a flexible sheet material, adhering the graphic onto the flexible sheet material with the heat adhesive layer; and the surface film layer covering the cut graphic.

Preferably, the step 4 of the method comprises: preparing a transfer film, transferring the cut graphic to the transfer film, applying a hot ironing process to the transfer film comprising the graphic on the flexible sheet material to bond the graphic onto the flexible sheet material, and removing the transfer film.

Preferably, in the step 3 of the method, a cutting depth of cutting out the graphic cuts off the surface film layer, the second adhesive layer, the printing layer and the heat adhesive layer.

Another method of forming a graphic on a flexible sheet material provided by the invention, comprising following steps of:
step 1, preparing a printable heat transfer material, the heat transfer material having a printing layer and a heat adhesive layer, printing a pattern on the printing layer of the heat transfer material;
step 2, cutting out a graphic from the heat transfer material, removing parts other than the graphic;
step 3, hot ironing the cut graphic onto a flexible sheet material, adhering the graphic onto the flexible sheet material with the heat adhesive layer;
step 4, preparing a covering film, the covering film comprising a transparent or translucent surface film layer and a second adhesive layer, cutting out a graphic film being able to cover the graphic from the covering film; and
step 5. adhering the graphic film onto the graphic with the second adhesive layer, and the surface film layer of the graphic film covering the graphic.

Preferably, the step 3 of the method comprises: preparing a transfer film, transferring the cut graphic to the transfer film, applying a hot ironing process to the transfer film comprising the graphic on the flexible sheet material to bond the graphic onto the flexible sheet material, and removing the transfer film.

Preferably, in the step 2 of the method, a cutting depth of cutting out the graphic cuts off the printing layer and the heat adhesive layer; in the step 4, after cutting out the graphic film from the covering film, discarding parts other than the graphic film.

Through either of the above two methods, consumers can make the graphic with the pattern on the surface of the flexible sheet material by DIY, and consumers can design or decide shape, pattern, style and color of the graphic and the pattern thereof by themselves. The surface film layer covers the graphic and the pattern, the graphic and the pattern thereof are capable of withstanding washing in water, maintaining an integrity, and maintaining vividness of colors. In addition to the heat transfer material, manufacturers only need to produce a few styles of the covering film, and therefore production requirements and product inventory can be significantly reduced.

Preferably, the heat transfer material comprises a carrier layer; the printing layer and the heat adhesive layer are detachably disposed on the carrier layer.

Preferably, the covering film comprises a release layer, the surface film layer and the second adhesive layer are disposed on the release layer, and the surface film layer is located between the release layer and the second adhesive layer.

Preferably, the graphic film is cut into a shape being the same or approximately the same as that of the graphic.

Preferably, one surface of the release layer is an embossed surface and is provided with a concave-convex texture; one surface of the surface film layer is in contact with the embossed surface, and the surface is formed with a concave-convex texture.

Preferably, one surface of the surface film layer of the covering film is bonded with the second adhesive layer, and another surface is a textured surface with a concave-convex texture or a texture that forms a laser effect, the texture with the laser effect is capable of forming a surface effect similar to that of a laser treatment or a 2D/3D effect.

Preferably, the covering film comprises a zinc sulfide layer bonded with one surface of the surface film layer, and the zinc sulfide layer causes a light ray reflected by the surface film layer to have an iridescent effect.

Preferably, the covering film comprises a metal layer bonded with one surface of the surface film layer, the metal layer is only partially bonded with the surface film layer, so that the surface film layer forms a partially transparent and partially opaque bronzing film/foil film.

Preferably, the surface film layer of the covering film is added with pearlescent powder, glitter powder or luminous powder, the pearlescent powder gives the surface film layer an iridescent effect, the glitter powder gives the surface film layer a metallic luster, the luminous powder gives the surface film layer a luminous effect.

Preferably, one surface of the surface film layer is provided with micro optical components, including: micro convex lenses, micro concave lenses, and micro convex or concave water droplet-shaped components, so that the surface film layer produces light reflection and refraction effects.

Preferably, the surface film layer is a transparent or translucent reflective layer with reflective components that reflect light.

Preferably, the second adhesive layer of the covering film is a hot melt adhesive layer capable of producing viscosity when being heated.

### BRIEF DESCRIPTION OF DRAWINGS

The objects, features, and achieved efficacies of the invention can be understood from the description and drawings of the following preferred embodiments, in which:

FIG. 1 is a cross-sectional view of a heat transfer material used in a method of the invention.

FIG. 2 is a cross-sectional view of a covering film used in the method of the invention.

FIGS. 3, 4, 4A, 5 and 6 are cross-sectional views of the covering film according to several embodiments of the invention, the release layer is omitted in the FIGS., wherein FIG. 4A is a top view of FIG. 4.

FIGS. 7 and 8 are cross-sectional views of the covering film according to two embodiments of the invention.

FIGS. 9A to 16 illustrate the operation of production steps of a method of forming a graphic on a flexible sheet material and finished products of a first preferred embodiment of the invention.

FIG. 17 is a cross-sectional view of a finished product, a flexible sheet material with a graphic formed on a surface thereof, of FIG. 16.

FIG. 17A is a cross-sectional view of another finished product of a first preferred embodiment the invention.

FIGS. 18 to 30 illustrate the operation of production steps of the method and finished products of a second preferred embodiment of the invention.

FIG. 31 is a cross-sectional view of a finished product, a flexible sheet material with a graphic formed on a surface thereof, of FIG. 30.

FIG. 32 shows another finished product produced by the method of the invention.

FIGS. 33 to 36 show another finished product of the invention.

### DETAILED DESCRIPTION OF THE INVENTION

The invention discloses a method of two preferred embodiments. Through a printable heat transfer material, a covering film, and production steps disclosed in the invention, consumers are capable of forming a graphic with a pattern on various types of flexible sheet materials, the flexible sheet material can be any kinds of cloth, leather or plastic films. The cloth can be various fabrics or non-fabrics, and can be used as material in various clothing, apparels, bags or sacks, such as but are not limited to, various men's or women's clothes, various pants and trousers, socks, shoes, head scarves, scarves, bags, backpacks, handbags, etc. The specification takes cloth as an example of the flexible sheet material and illustrates how to form graphics on cloth. The same manufacturing method can be applied to leather and plastic films.

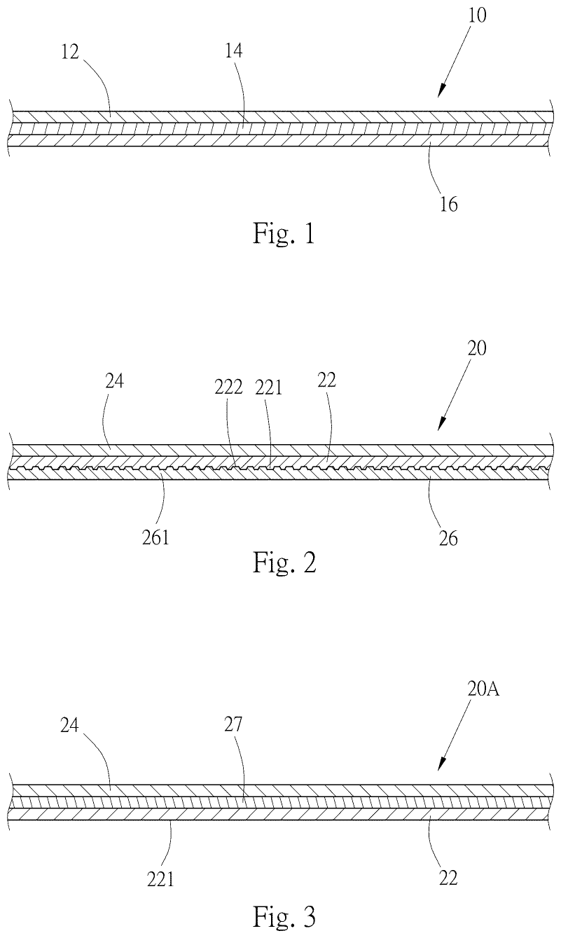

Please refer to FIGS. 1 and 2, which are cross-sectional views of a printable heat transfer material 10 and a covering film 20 used in the method of the invention. The heat transfer material 10 comprises a printing layer 12 and a heat adhesive layer 14 bonded with a surface (an inner surface) of the printing layer 12. The heat adhesive layer is a hot melt adhesive layer. The printing layer 12 and the hot melt adhesive layer 14 are disposed on a carrier layer 16, and the hot melt adhesive layer 14 is located between the printing layer 12 and the carrier layer 16. Ink or toner can be used to print a pattern on another surface (an outer surface) of the printing layer 12 through an inkjet or a laser printer. The heat transfer material 10 disclosed in the embodiment of the invention is a water-based heat transfer material, which is environmentally friendly to Earth. A material of the printing layer 12 is not limited to that shown in the embodiment. A material of the carrier layer 16 can be paper or high molecular polymer, and preferably has release properties. The printing layer 12 and the hot melt adhesive layer 14 can be peeled off from the carrier layer 16 together.

The covering film 20 is a special film material provided by the invention, and comprises a surface film layer 22 and a second adhesive layer 24 bonded with one surface of the surface film layer 22, and another surface 221 of the surface film layer 22 is bonded with a release layer 26. A material of the release layer 26 is PET (polyethylene terephthalate) or CPP (cast polypropylene), or it can also be paper. The surface film layer 22 is a transparent or translucent layer, such as a polymer film, such as PU film, but is not limited thereto. In FIG. 2, the surface film layer 22 is formed by coating liquid PU on the release layer 26. The second adhesive layer 24 is preferably a heat adhesive layer that generates viscosity when being heated. In a preferred embodiment of the invention, the second adhesive layer 24 is a transparent hot melt adhesive, which can be a hot melt adhesive of PP, TPE (thermoplastic elastomer), TPU (thermoplastic polyurethane), PES (polyethersulfone) or EVA (ethylene vinyl acetate), and is provided on the other surface 221 of the surface film layer 22 by coating or attaching.

Please refer to FIG. 2, one surface of the release layer 26 can be made into an embossed surface 261 with textures, such as various concave-convex textures, for example, micro or tiny concave-convex textures, preferably micro concave-convex textures. The concave and convex textures can be regular or irregular textures, including, but not limited to, dotted or striped textures. Therefore, after the surface film layer 22 is coated on the embossed surface 261 and formed, a surface of the surface film layer 22 in contact with the embossed surface 261 forms a processed or specially produced textured surface 221 with a texture 222 having concave-convex embossed textures. The texture 222 is a texture mirrored on the texture surface 261. The surface film layer 22 and the second adhesive layer 24 can be peeled off from the release layer 26 together.

Alternatively, the texture 222 of the textured surface 221 of the surface film layer 22 has a transparent laser effect exteriorly, that is, the textured surface 221 presents a surface effect similar to that of a laser treatment or a 2D/3D visual effect. The texture 222 can be formed through the embossed surface 261 of the release layer 26.

Please refer to FIG. 3. Alternatively, one surface of the surface film layer 22 of a covering film 20A is coated with a zinc sulfide layer 27, so that the surface film layer 22 has an iridescent effect, that is, a light reflected by the surface film layer 22 is a colorful light. The zinc sulfide layer 27 is located between the surface film layer 22 and the second adhesive layer 24.

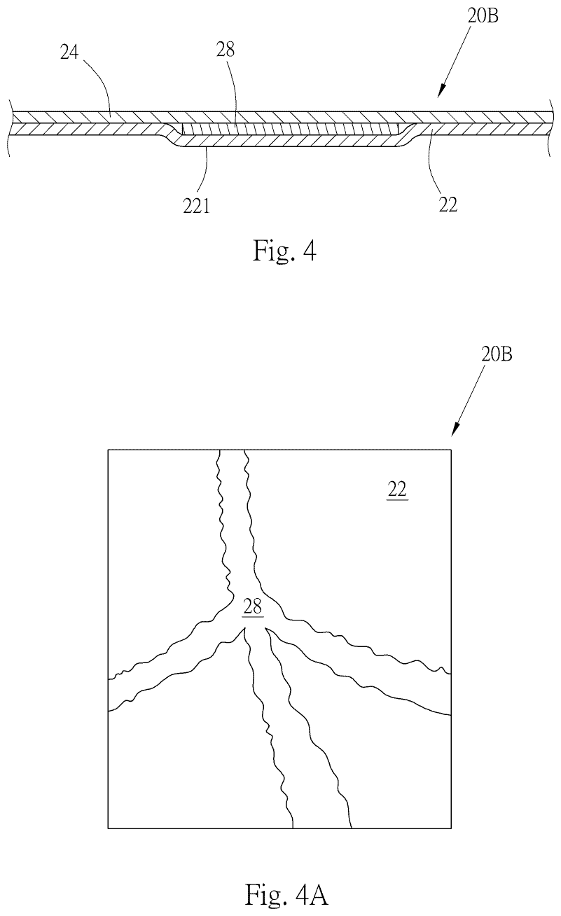

Please refer to FIG. 4. Alternatively, a metal layer 28 is provided on one surface of the surface film layer 22 of a covering film 20B. The metal layer 28 can be a chromium plating layer, an aluminum plating layer, or other suitable metal layers, disposed on one surface of the surface film layer 22 by plating or coating, and located between the surface film layer 22 and the second adhesive layer 24, so that the surface film layer 22 forms a foil (hot stamping foil) film. Please refer to FIG. 4A, which is a top view of the covering film 20B, showing only the surface film layer 22 and the metal layer 28. The metal layer 28 is only disposed on a partial surface of the surface film layer 22 and does not cover the entire surface film layer 22. Therefore, parts of the surface film layer 22 that are not covered by the metal layer 28 remain transparent or translucent to display the pattern on the heat transfer material 10. The metal layer 28 can have a regular or irregular shape, Including dotted and striped shapes. FIG. 4A illustrates a shape of the metal layer 28, which is not intended to be a limitation.

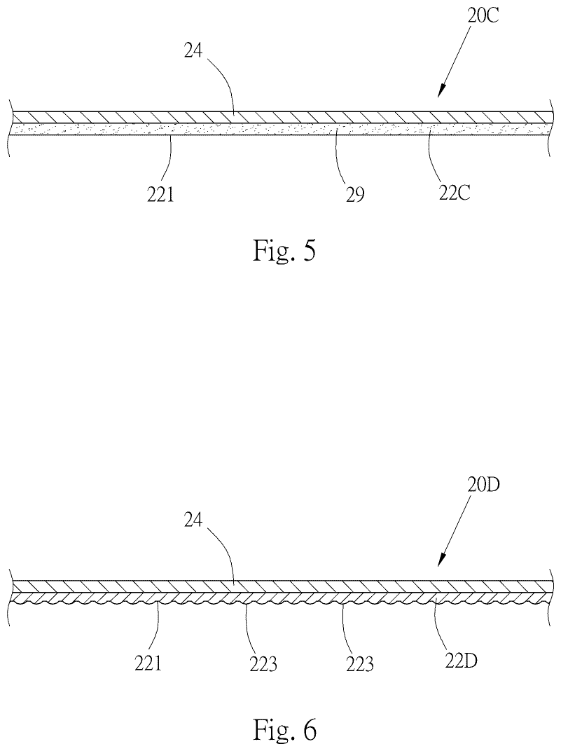

Please refer to FIG. 5. Alternatively, a surface film layer 22C of a covering film 20C is mixed with an additive 29 with a weight ratio of 1 to 5%. The additive 29 can be pearlescent powder, glitter powder (micro aluminum foil with colors) or luminous powder (luminous particles), the pearlescent powder gives the surface film layer 22C an iridescent effect, the glitter powder gives the surface film layer 22C a metallic luster, and different colors of glitter powder produce different colors of metallic luster. The luminous powder makes the surface film layer 22C have a luminous effect and capable of emitting light at night.

Please refer to FIG. 6. Alternatively, the textured surface 221 of a surface film layer 22D of a covering film 20D forms a micro optical structure provided with micro or tiny optical components, such as micro convex lenses 223 or concave lens, or micro water droplet-shaped components (referred to as small water droplets). Preferably, the convex lenses 223, concave lenses or small water droplets are formed by the embossed surface 261 of the release layer 26. Each of the convex lenses 223 is a convex structure, protruding from the textured surface of the surface film layer 22D; each of the concave lenses is a concave structure, recessed from the textured surface 221 of the surface film layer 22D; each of the small water droplets can be a convex or concave structure. Through the convex lenses 223, the concave lenses or the small water droplets, the surface of the surface film layer 22D produces light reflection and refraction effects.

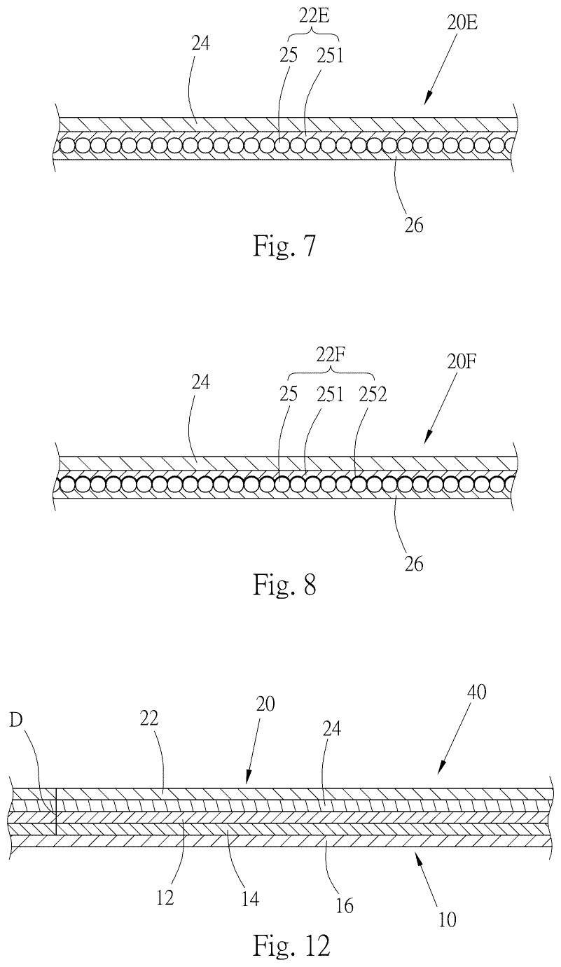

Alternatively, the surface film layer of the covering film is a lay of transparent or translucent reflective components. Please refer to FIG. 7, the covering film 20E has a transparent or translucent reflective layer 25 as the surface film layer 22E. The reflective layer 25 is a layer of micro glass beads. One surface of the glass bead layer 25 is bonded to the second adhesive layer 24 with a layer of transparent or translucent glue or adhesive 251. The release layer 26 is provided on the other surface of the glass bead layer 25. The surface film layer 22E and the second adhesive layer 24 can be separated from the release layer 26 together.

Alternatively, please refer to FIG. 8. The covering film 20F has a transparent or translucent surface film layer 22F, a second adhesive layer 24 and a release layer 26. The surface film layer 22F includes a glass microbead layer 25, a layer of transparent or translucent glue or adhesive 251 and a layer of zinc sulfide 252. The zinc sulfide is coated or plated on a surface of the glass bead layer 25 and located between the glass bead layer 25 and the second adhesive layer 24. The adhesive 251 is a hot melt adhesive of TPU, PUR (Polyurethane Reactive) or acrylic family. The surface film layer 22F is reflective, and the reflective light has an iridescent effect by the zinc sulfide layer 252. The surface film layer 22F and the second adhesive layer 24 can be separated from the release layer 26 together.

In one embodiment disclosed in this specification, the surface film layers 22 and 22F with the zinc sulfide layers 27 and 252 and the surface film layer 22C with pearlescent powder or glitter powder added are translucent film materials. The surface film layer 22 in FIG. 2, the surface film layer 22 with the metal layer 28 in FIG. 4, and the surface film layer 22D and 22E in FIGS. 6 and 7 can be transparent or translucent film materials.

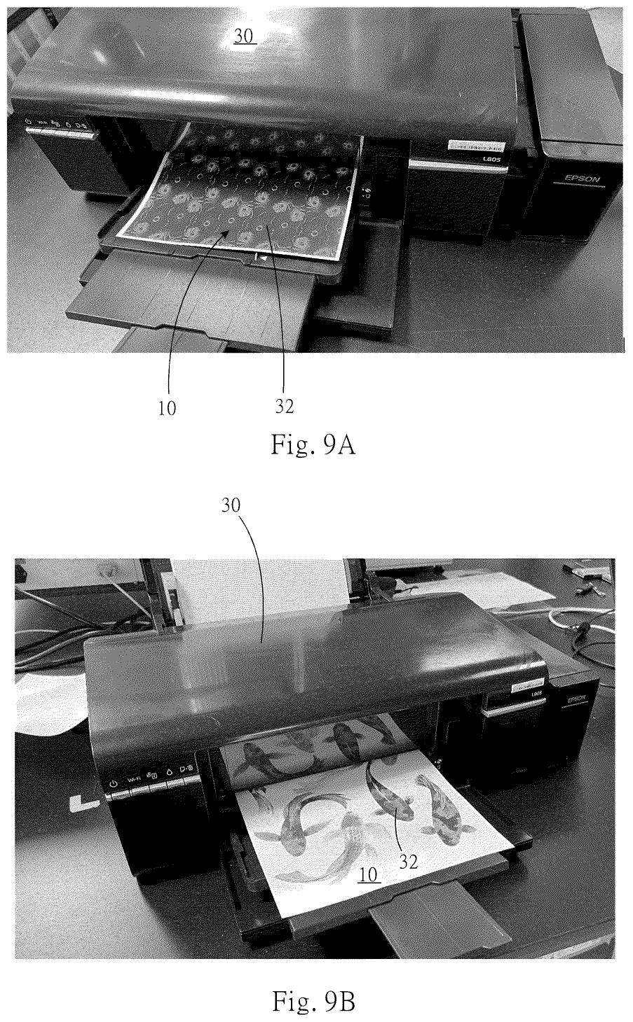

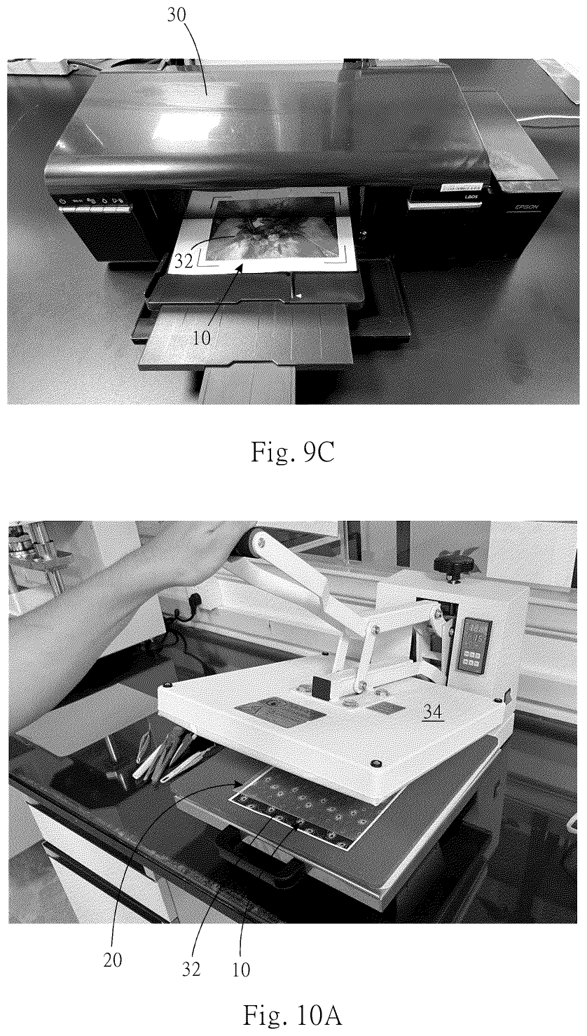

FIGS. 9A to 16 show a method of forming a graphic on cloth according to a first preferred embodiment of the invention, which comprises steps described hereinafter. The covering film 20 and the surface film layer 22 described below comprise and can be the covering film and the surface film layer shown in each of the embodiments of FIG. 2 to FIG. 8.

Step 1: preparing a printable heat transfer material 10 as shown in FIG. 1, and printing a pattern 32 on the heat transfer material 10.

Computer printing is a printing technology that can be implemented by ordinary households. FIGS. 9A to 9C shows that through computer printing consumers use a household printer 30 of EPSON or HP brand to print a pattern 32 onto the printing layer 12 of the heat transfer material 10 by ink or toner. The pattern 32 can be various graphics such as characters, animals, non-characters, non-animals, texts or non-texts, and can be monochromatic or chromatic, preferably chromatic. FIGS. 9A to 9C show three different patterns 32, including a non-animal pattern with feathers in FIG. 9A, a fish pattern in FIG. 9B, and a character pattern in FIG. 9C. Consumers can design and print textures, styles and colors of the pattern 32 by themselves. Ink that can be printed on the printing layer 12 can be dye ink or sublimation ink (also called thermal sublimation ink).

Step 2: preparing a covering film 20 shown in FIG. 2, and bonding the covering film 20 onto the printing layer 12 of the heat transfer material 10 to cover the pattern 32.

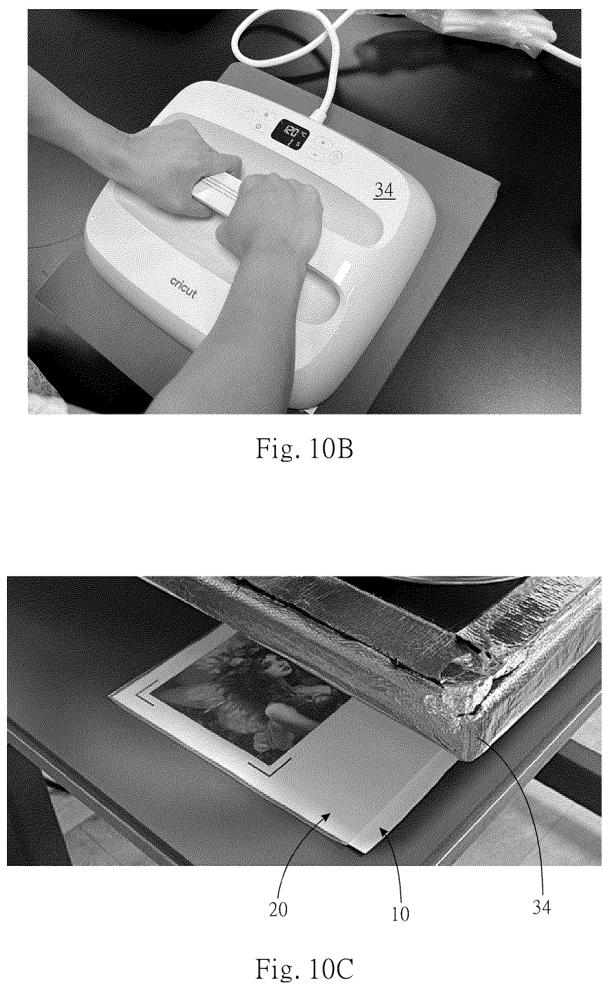

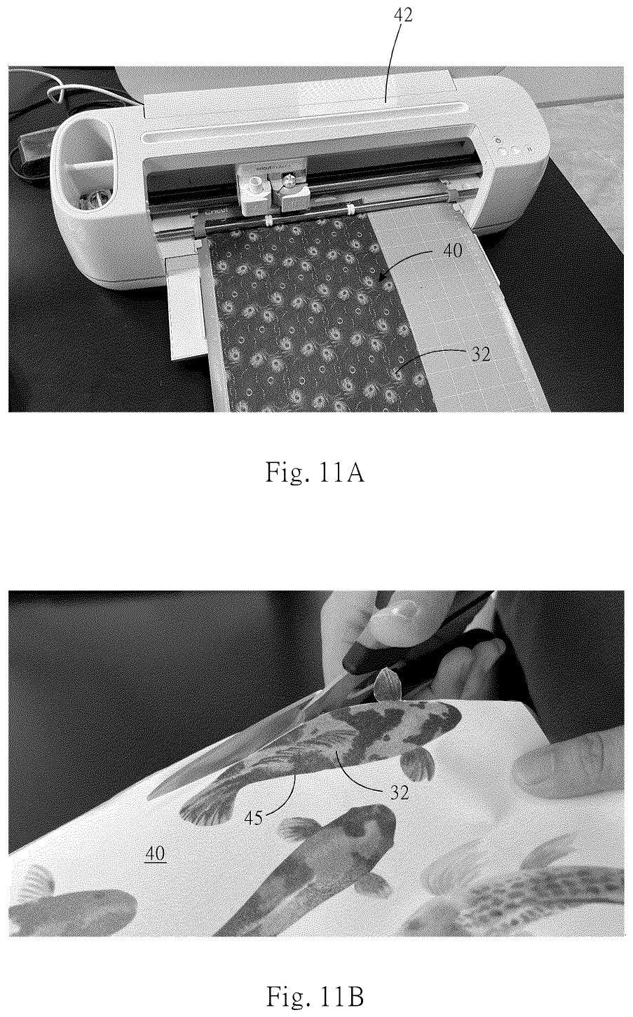

Please refer to FIG. 10 (including FIGS. 10A to 10C), the covering film 20 is placed on the heat transfer material 10, and the covering film 20 is adhered to the printing layer 12 of the heat transfer material 10 with the second adhesive layer 24 to cover the pattern 32. The second adhesive layer 24 is a hot melt adhesive that generates viscosity when being heated. Therefore, consumers can use hot ironing devices they have at home, such as an electric iron or a hot ironing machine 34 shown in FIGS. 10A and 10C to heat the covering film 20 and the heat transfer material 10 to adhere the covering film 20 onto the printing layer 12 through the second adhesive layer (hot melt adhesive) 24 to cover and protect the pattern 32. After the covering film 20 and the heat transfer material 10 are adhered with each other, the release layer 26 of the covering film 20 is peeled off, and only the surface film layer 22 of the covering film 20 is left to adhere on the heat transfer material 10. The surface film layer 22 is adhered on the printing layer 12 to cover the pattern 32 so that the pattern 32 does not come into contact externally.

Step 3: cutting out a graphic from the adhered heat transfer material and the covering film.

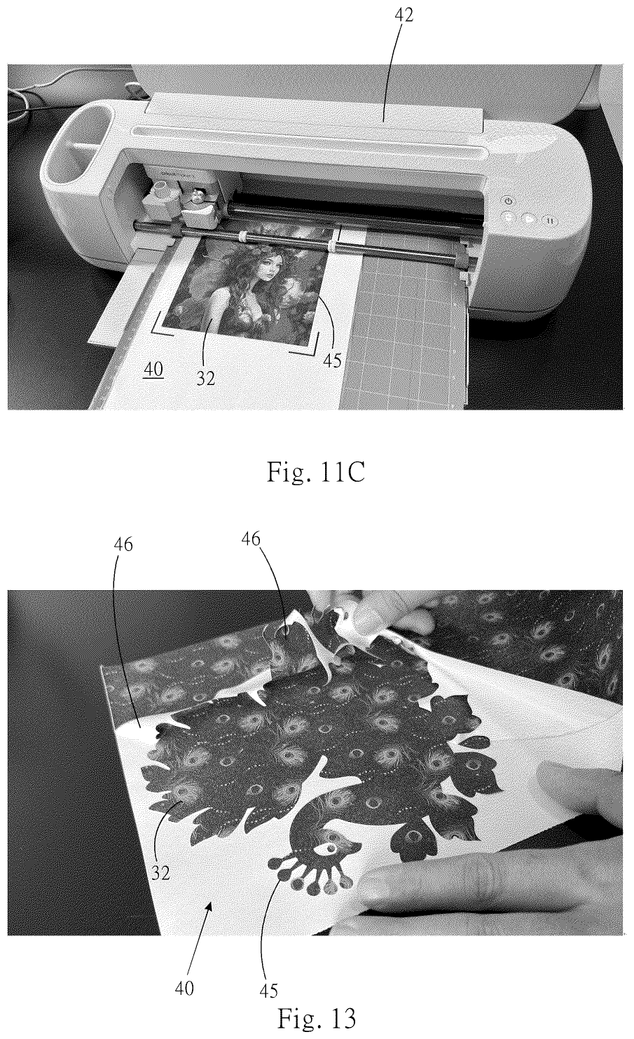

In the step 2, the heat transfer material 10 and the surface film layer 22 of the covering film 20 are laminated to form a laminated film material 40. Then, a graphic is cut out from the laminated film material 40. Please refer to FIG. 11 (including FIGS. 11A to 11C), the graphic is cut out from the laminated film material 40. Consumers can use a household cutting machine 42 as shown in FIG. 11A to perform cutting, for example, a CRICUT graphic cutting machine can be used. Alternatively, as shown in FIG. 11B, the graphic can be manually cut out from the laminated film material 40 with a cutting tool such as a utility knife or scissors. The household cutting machine 42 is controlled by a computer to perform pattern cutting. A bird graphic in FIG. 13 is a graphic 45 cut out by the cutting machine 42 in FIG. 11A. Please refer to FIG. 12, a cutting depth D of a cutter of the cutting machine 42 cuts off the surface film layer 22, the second adhesive layer 24, the printing layer 12 with a printing pattern, and the hot melt adhesive layer 14. FIG. 11B shows that the fish graphic 45 is cut out with scissors. FIG. 11C shows the cutting machine 42 cutting out the graphic 45 from the laminated film material 40. The cutting machine 42 cuts out an outline of the pattern 32 and cuts out a rectangular graphic 45.

Step 4: removing parts (waste material) other than the graphic 45 and keeping the cut graphic.

Please refer to FIG. 13, parts other than the graphic 45 are peeled off, that is, a waste material 46 that does not belong to the graphic 45 is peeled off, and only the graphic 45 is retained. The graphic 45 formed by cutting comprises the hot melt adhesive layer 14, the printing layer 12 with the pattern 32 printed on it, the second adhesive layer 24 and the surface film layer 22 of a same shape and stacked together from bottom to top.

Step 5: hot ironing the cut graphic onto cloth, an inner surface of the cut graphic is adhered onto the cloth with the hot melt adhesive layer, and the surface film layer covering an outer surface of the cut graphic.

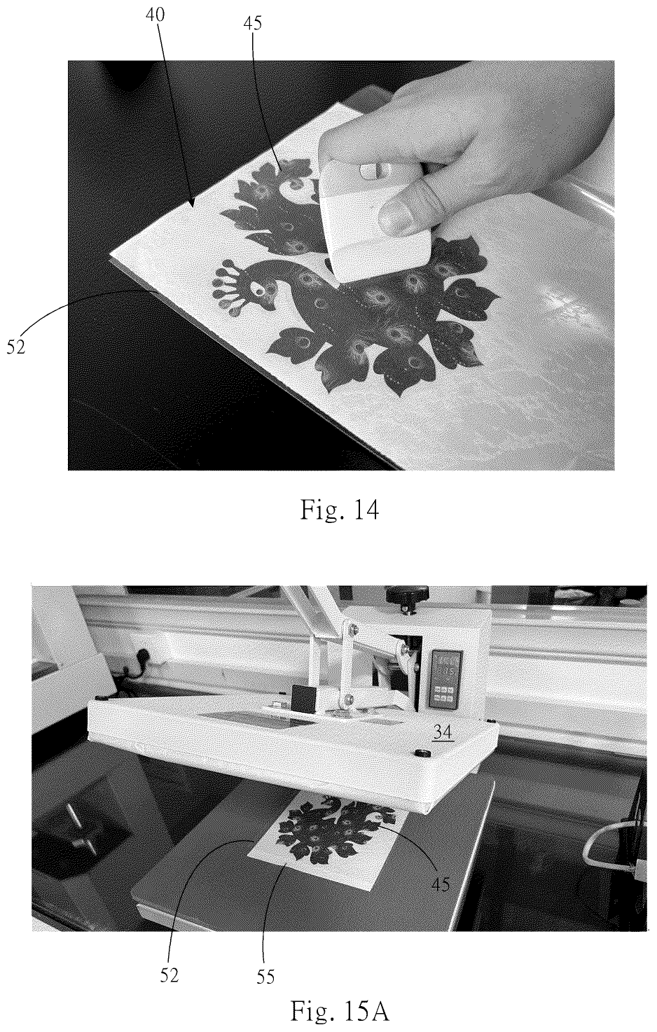

Please refer to FIG. 14, using a transfer film 52, and transferring the cut graphic 45 onto the transfer film 52. After the graphic 45 is transferred onto the transfer film 52, the graphic 45 is separated from the carrier layer 16 of the heat transfer material 10. As mentioned above, the printing layer 12 and the hot melt adhesive layer 14 are easily separated from the carrier layer 16. The graphic 45 (comprising the laminated surface film layer 22, the second adhesive layer 24, the printing layer 12 and the hot melt adhesive layer 14) is adhered or attached onto the transfer film 52 after being separated from the carrier layer 16.

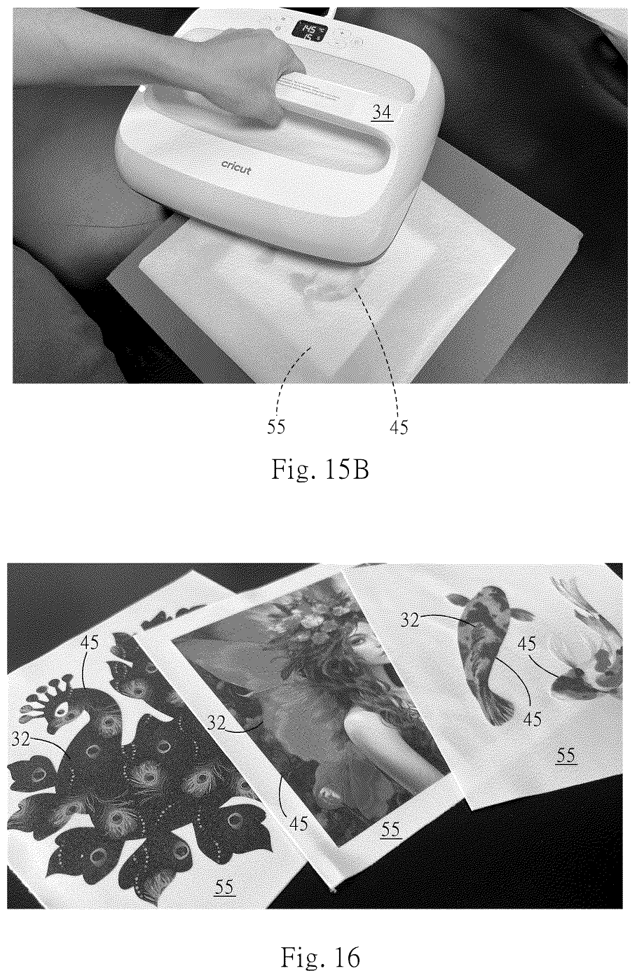

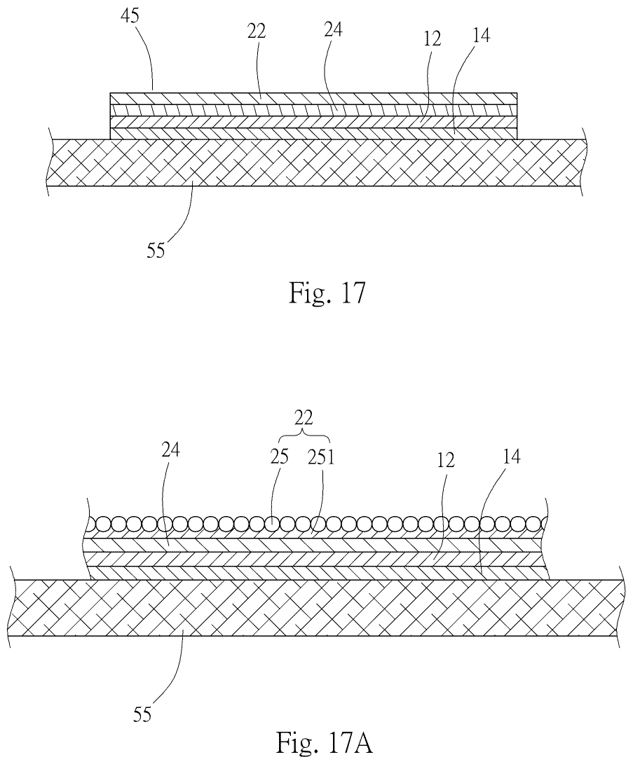

Then, as shown in FIG. 15 (including FIG. 15A and FIG. 15B), the transfer film 52 comprising the graphic 45 is placed on cloth 55, and the hot melt adhesive layer 14 of the graphic 45 contacts the cloth 55. The transfer film 52 and the graphic 45 are heated with an electric iron or a hot ironing machine 34. The hot melt adhesive layer 14 is heated and generates viscosity to adhere the graphic 45 to a surface of the cloth 55, as shown in FIGS. 16 and 17. The graphic 45 and the pattern 32 of the graphic are covered by the surface film layer 22, and the pattern 32 is isolated by the surface film layer 22.

FIG. 17A shows a cross-sectional view of a finished product made according to the method of the first preferred embodiment. The surface film layer 22 has a reflective effect when it is the surface film layer (22E, 22F) shown in FIG. 7 or FIG. 8. During the daytime, the surface film layer 22 is not reflective. At night, the glass bead layer 25 of the surface film layer reflects light, causing the pattern 32 to produce a reflective effect.

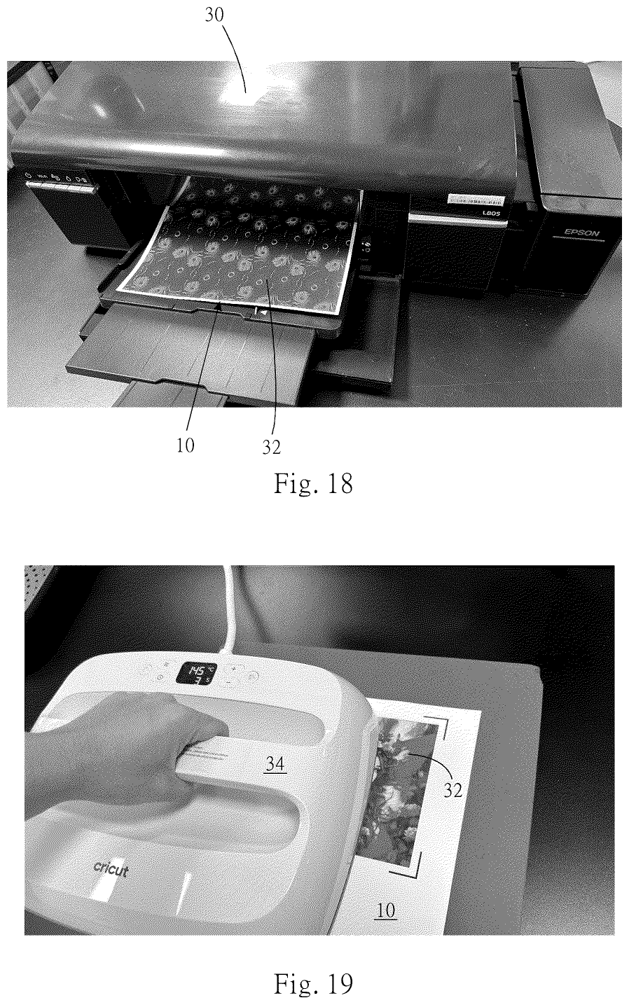

FIGS. 18 to 30 show a method of forming a graphic on cloth according to a second preferred embodiment of the invention, which comprises following steps. The covering film 20 and the surface film layer 22 described below comprise and can be the covering film and the surface film layer shown in each of the embodiments of FIG. 2 to FIG. 8.

Step 1: preparing a printable heat transfer material 10 as shown in FIG. 1, and printing a pattern 32 on the heat transfer material 10.

As shown in FIG. 18, a household printer 30 is used to print a pattern 32 onto the printing layer 12 of the heat transfer material 10 through computer printing. The pattern 32 can be various graphics such as characters, animals, non-characters, non-animals, texts or non-texts. This step is the same as the printing steps shown in FIGS. 9A to 9C.

Please refer to FIG. 19. After the pattern 32 is printed, the pattern 32 can be heated with an electric iron or a hot ironing machine 34 to dry the ink of the pattern 32 to shape the pattern 32.

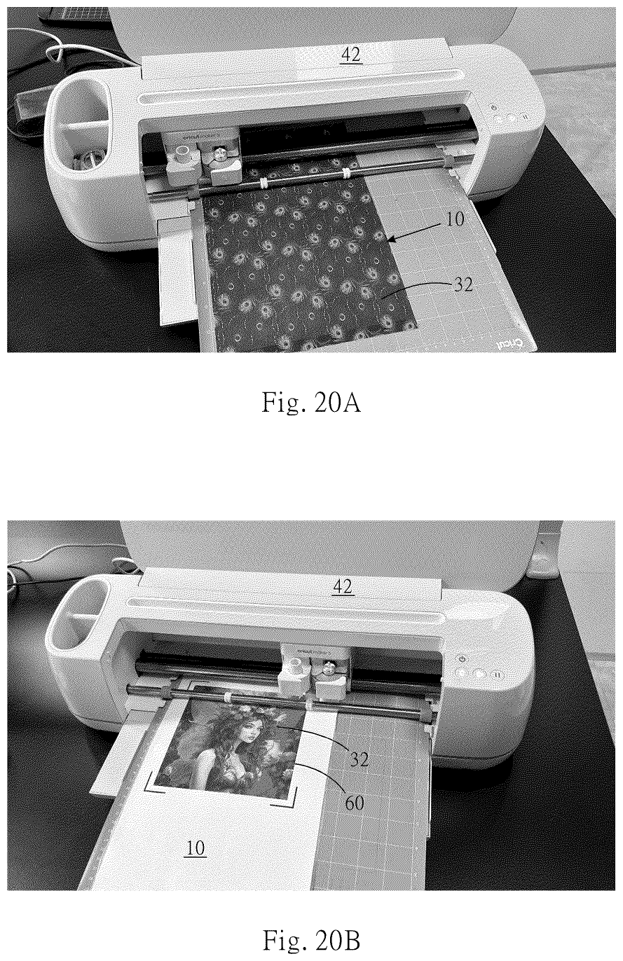

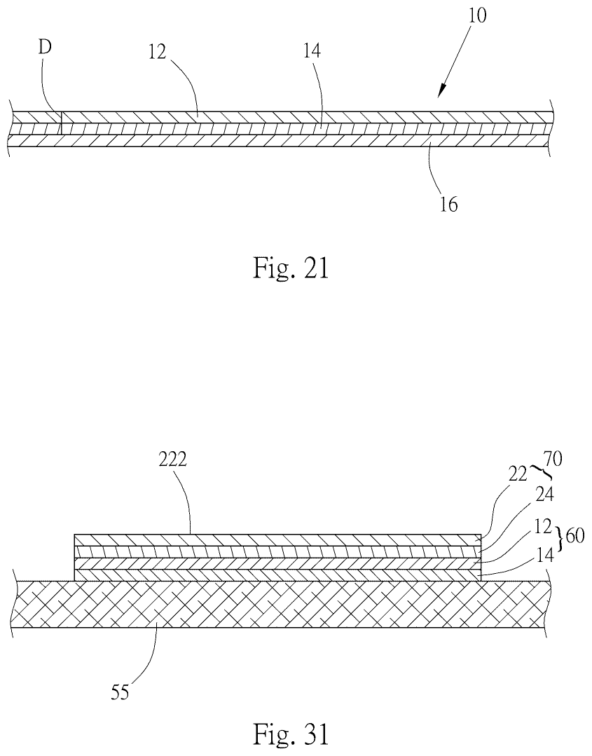

Step 2: cutting out a graphic 60 from the heat transfer material 10, removing parts other than the graphic 60, and keeping the graphic 60 Similar to what is shown in FIG. 11B, the graphic 60 can be manually cut out from the heat transfer material 10 with a utility knife or scissors; or as shown in FIG. 20A or FIG. 20B, the graphic 60 can be cut out from the heat transfer material 10 with a household cutting machine 42 through a computer. The cutting depth D of the graphic 60 cuts off the printing layer 12 and the hot melt adhesive layer 14, as shown in FIG. 21.

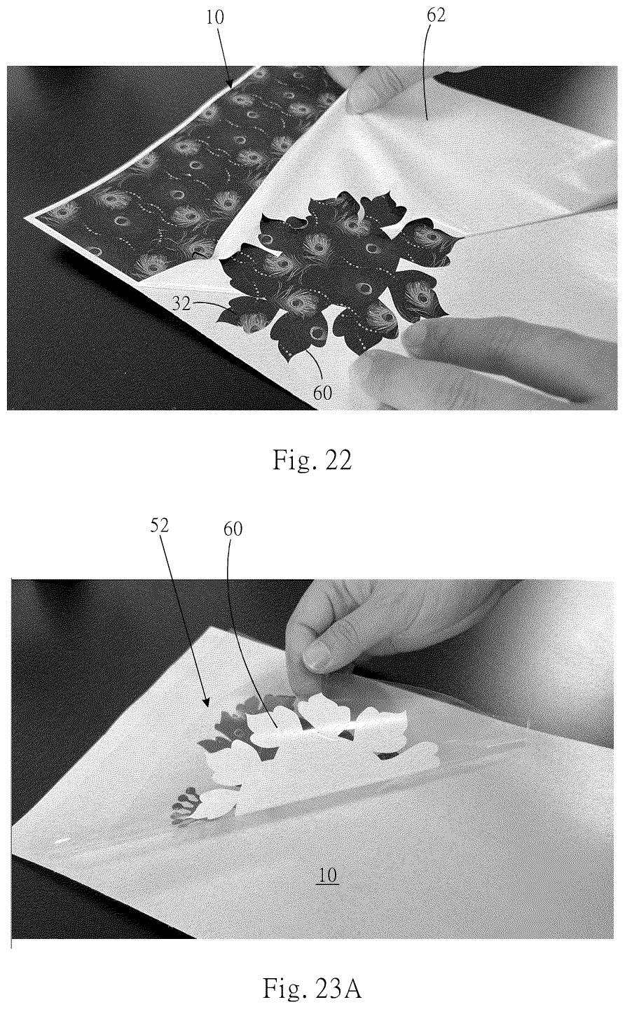

Then, as shown in FIG. 22, parts other than the graphic 60 are peeled off, that is, a waste material 62 is removed, leaving only the graphic 60 on the carrier layer 16. At this time, the graphic 60 comprises the printing layer 12 with the pattern 32 printed thereon and the hot melt adhesive layer 14.

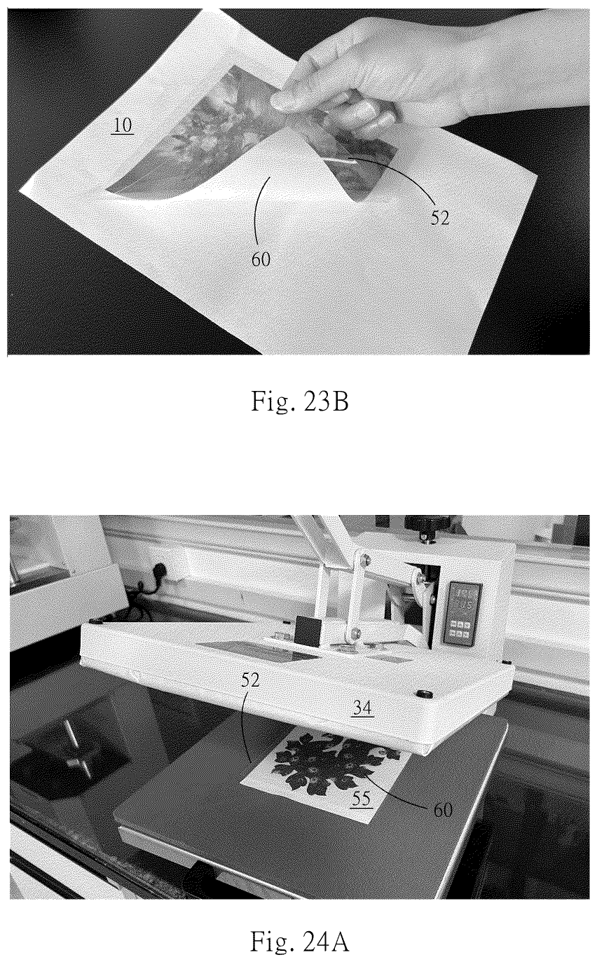

Step 3: hot ironing the cut graphic 60 onto cloth, adhering the graphic 60 onto cloth with the hot melt adhesive layer 14 Please refer to FIG. 23 (including FIG. 23A and FIG. 23B), using a transfer film 52, and transferring the cut graphic 60 onto the transfer film 52. After the graphic 60 is transferred onto the transfer film 52, the graphic 60 is separated from the carrier layer 16 of the heat transfer material 10.

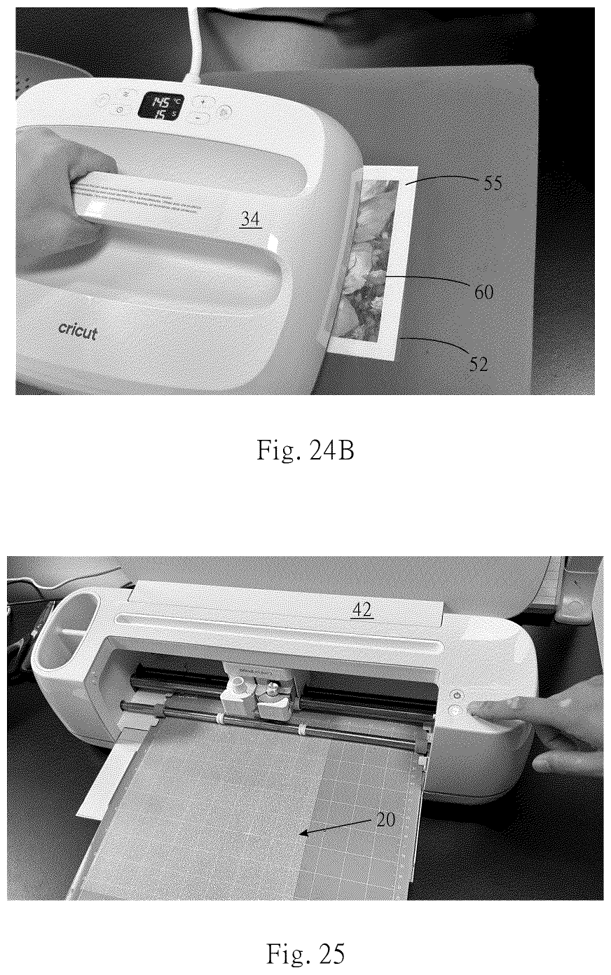

Then, as shown in FIG. 24 (including FIGS. 24A and 24B), the transfer film 52 comprising the graphic 60 is placed on cloth 55, and the hot melt adhesive layer 14 of the graphic 60 contacts the cloth 55. The transfer film 52 and the graphic 60 are heated with an electric iron or a hot ironing machine 34 to adhere the graphic 60 onto the cloth 55 through a viscosity generated by heating the hot melt adhesive layer 14.

Step 4: preparing a covering film 20 as shown in FIG. 2, cutting out a graphic film 70 from the covering film to cover the graphic, a shape of the graphic film 70 is the same or approximately the same as that of the graphic 60, and removing a waste material 72 other than the graphic film 70.

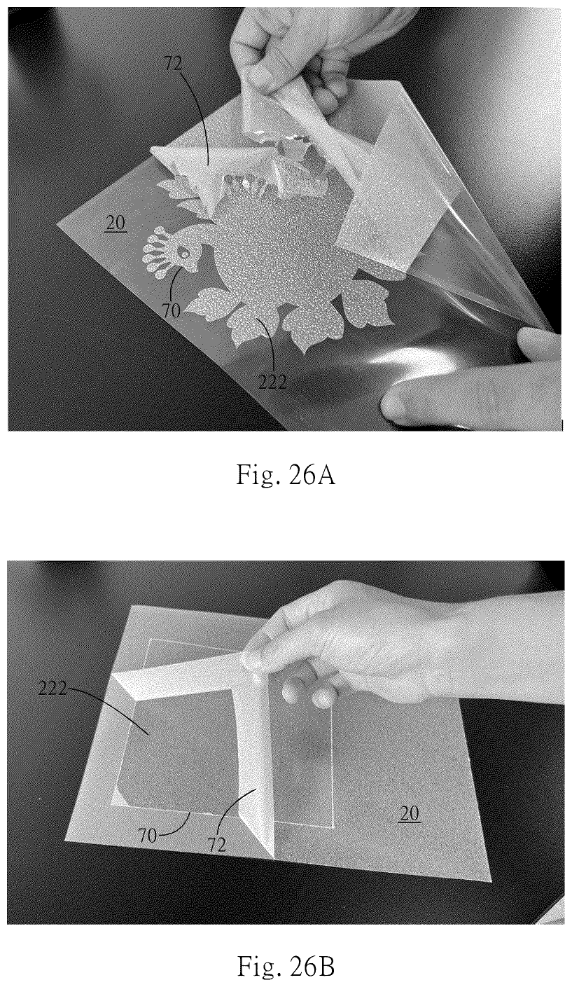

Using the covering film 20 shown in FIG. 2, and cutting out a graphic film 70 from the covering film 20 manually or with a household cutting machine 42 shown in FIG. 25. FIG. 26 shows the graphic film 70, a shape of the graphic film 70 is the same or approximately the same as a shape of the graphic 60. Through computer cutting, that is, the cutting machine 42 is controlled by a computer, the graphic film 70 consistent with a shape of the graphic 60 can be cut. The graphic film 70 having approximately a same shape as that of the graphic 60 can be cut manually. The graphic film 70 is preferably capable of covering the graphic 60 completely.

Then, as shown in FIG. 26 (including FIGS. 26A and 26B), parts other than the graphic film 70 are removed, that is, the waste material 72 is removed, so that the covering film 20 only retains the cut graphic film 70. The graphic film 70 comprises the laminated surface film layer 22 and the second adhesive layer 24. It can be seen from FIG. 25 and FIG. 26 that a surface of the surface film layer 22 has the micro concave-convex texture 222, making the surface film layer 22 a translucent film. FIGS. 25 and 26 only illustrate the texture 222 of a certain type, which is not intended to be a limitation.

Step 5: adhering the graphic film 70 onto the graphic 60 with the second adhesive layer 24, the surface film layer 22 of the graphic film 70 covering the graphic 60, that being, covering an outer surface of the graphic 60.

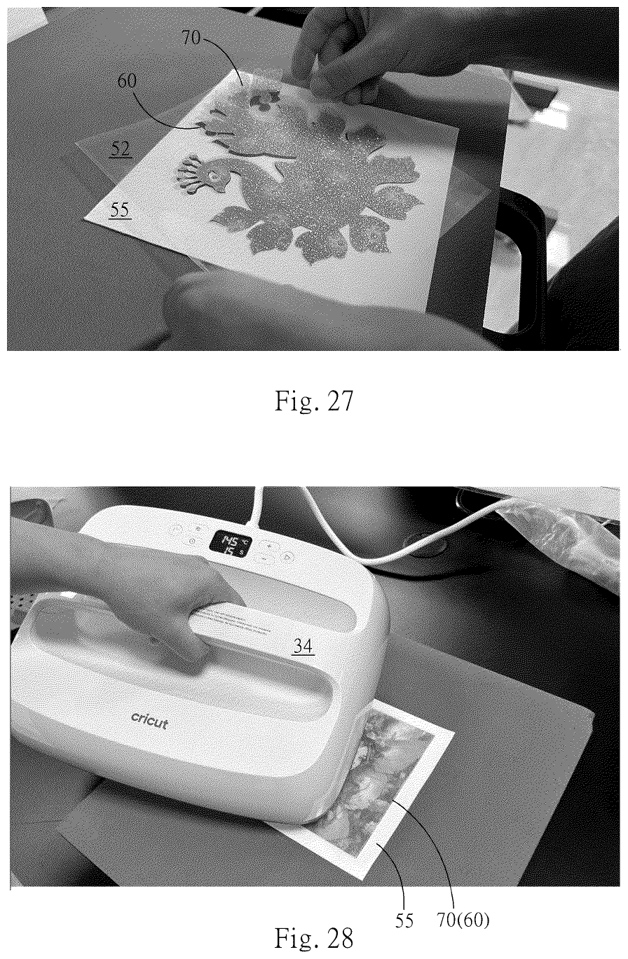

Please refer to FIG. 27, using a transfer film 52, and transferring the graphic film 70 onto the transfer film 52. The graphic film 70 is separated from the carrier layer 16 of the heat transfer material 10. At this time, the graphic film 70 is composed of the surface film layer 22 and the second adhesive layer 24 of the covering film 20 and is attached or adhered onto the transfer film 52. FIG. 27 shows that the graphic film 70 has been transferred onto the transfer film 52.

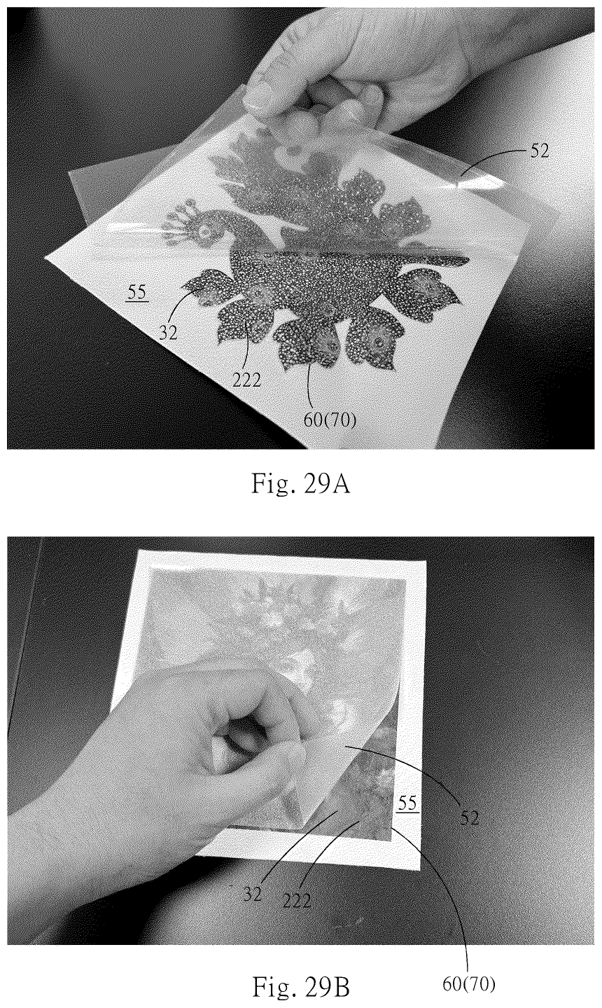

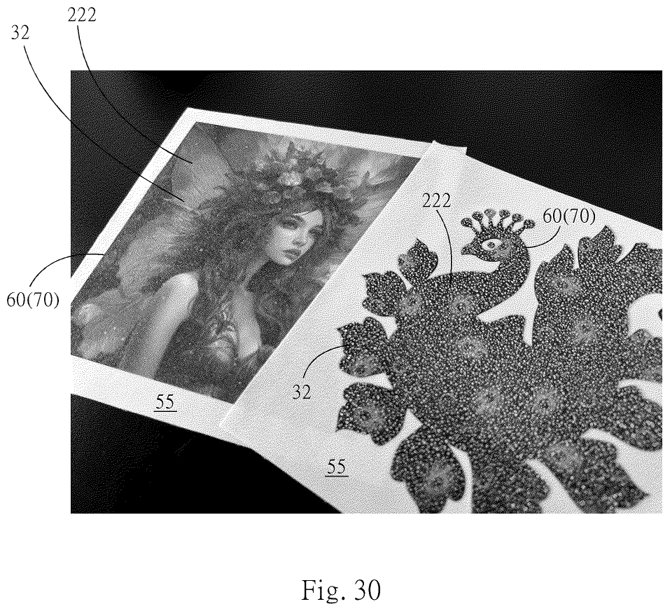

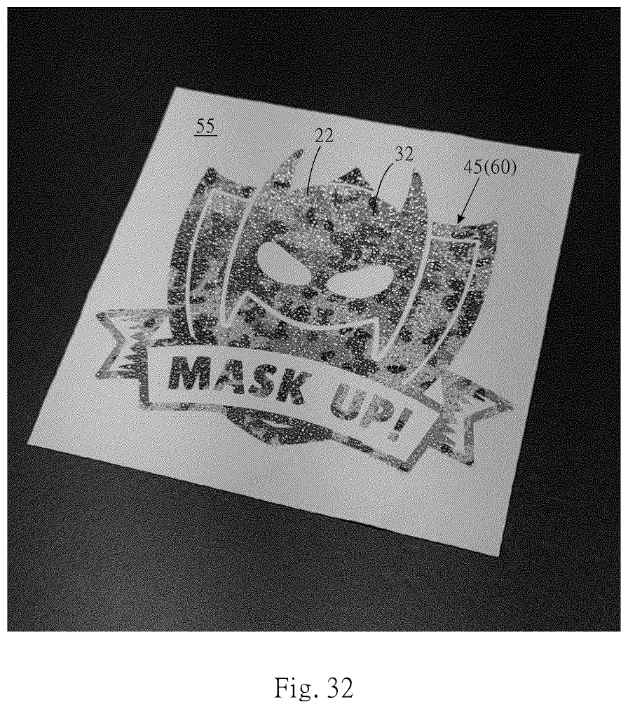

Then, as shown in FIG. 27, align the graphic film 70 with the graphic 60 on the cloth 55. As shown in FIG. 28, use an electric iron or a hot ironing machine 34 to heat the transfer film 52 and the graphic film 70 to cause the second adhesive layer (hot melt adhesive) 24 to generate viscosity, and to adhere the graphic film 70 onto the graphic 60. Lastly, as shown in FIG. 29 (including FIG. 29A and FIG. 29B), the transfer film 52 is peeled off to adhere the graphic 60 and the graphic film 70 onto the cloth 55 to complete the method of the invention. A finished product is shown in FIGS. 30 and 31. The graphic 60 and the graphic film 70 are adhered onto a surface of the cloth 55, and the graphic film 70 is adhered onto the graphic 60. The printed pattern 32 on the printing layer 12 is covered and protected by the surface film layer 22, the pattern 32 will not be damaged, and exteriors of the graphic 60 and the pattern 32 have a texture effect formed by the texture 222 of the surface film layer 22.

FIG. 32 shows another finished product of the method of the invention, which can be manufactured by the method of the first or second preferred embodiment. After being made, the graphic 45 (60) with the pattern 32 is formed on the cloth 55, and the pattern 32 of the graphic 45 (60) is covered by the surface film layer 22. The surface film layer 22 of the finished product has glitter powder, so the graphic 45 (60) produces a metallic luster effect.

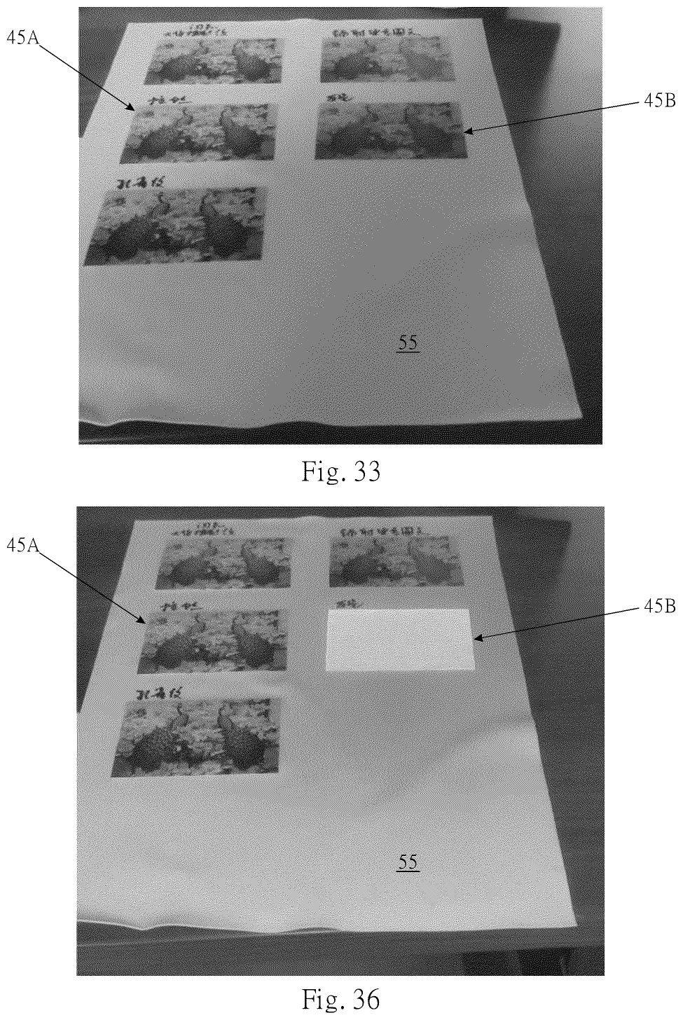

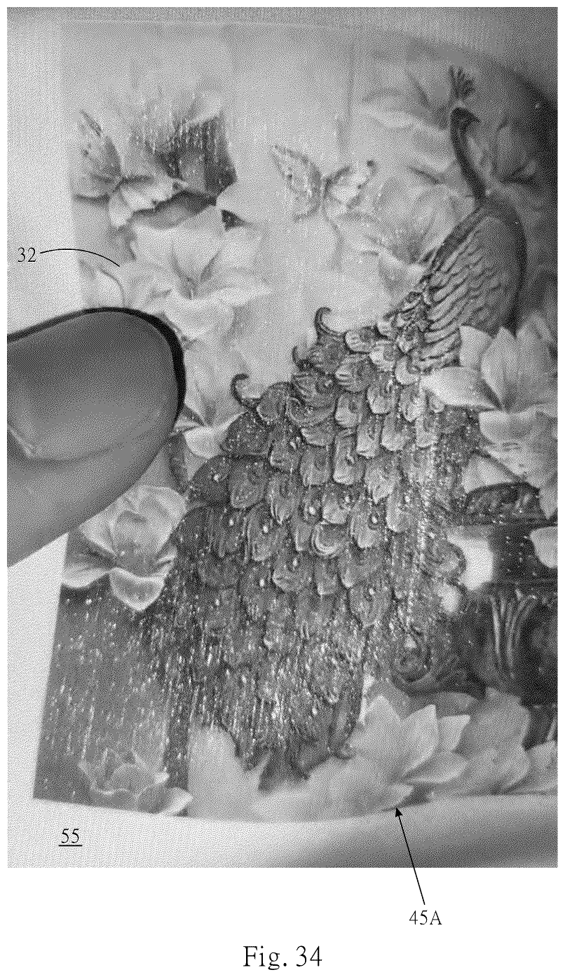

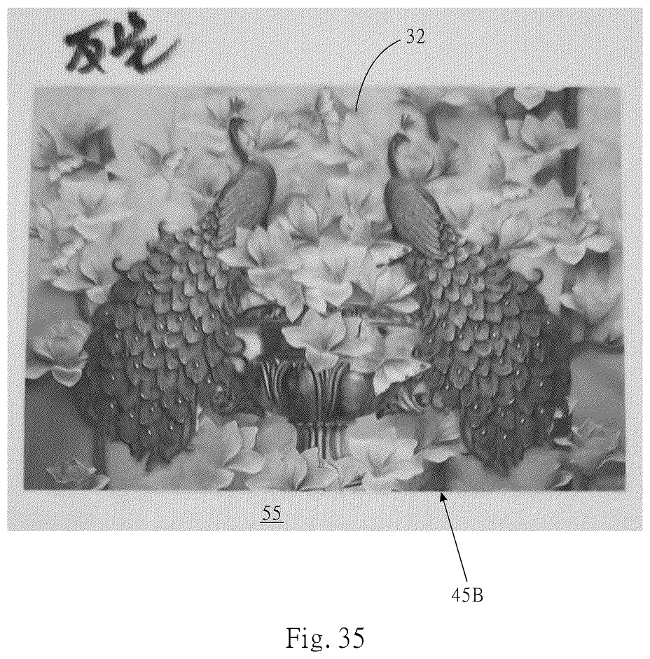

FIGS. 33 to 36 show another finished product of the manufacturing method of the present invention, in which a plurality of graphics 45 of peacock patterns 32 are made on cloth 55. The surface film layer of each graphic 45 has different surface effects, wherein: as shown in FIG. 34, the surface film layer of the graphic 45A has striped textures/striped lines. The structure of the graphic 45B is as shown in FIG. 17A, and the surface film layer of the graphic 45B is a reflective layer having a glass bead layer 25 of FIG. 7 or FIG. 8. As shown in FIGS. 33 and 35, the pattern of the graphic 45B can be seen when the graphic 45B is not reflective. At night or in a dark place, when light shines on the graphic 45B, as shown in FIG. 36, the surface layer film of the graphic 45B will reflect light, providing a safety effect.

The method provided by the invention is capable of forming the graphic 45 (60) with the pattern 32 on cloth such as clothes and pants. The graphic 45 (60) and the pattern 32 thereof are protected and isolated by the surface film layer 22. The graphic 45 (60) will not be damaged, and the ink or toner of the pattern 32 will not diffuse, spread or fall off, capable of maintaining an integrity of the graphic 45 (60) and the pattern 32 on the cloth, as well as maintaining a vividness of colors of the pattern 32. Tested by the inventor, the cloth was washed twenty times at a water temperature of 60° C. and dried after each washing, the graphic 45 (60) and the pattern 32 remained intact, colors remained bright and vivid, and there was no damage or color fading.

The textured surface 221 of the surface film layer 22 can produce the texture 222, so that the pattern 32 has a texture effect, such as the texture 222 shown in FIG. 30, or a 2D/3D visual effect. The surface film layer 22 can also be coated with a zinc sulfide layer or a metal layer, so that the pattern 32 has an iridescent effect or a bronzing effect. The metal layer does not cover the entire surface film layer 22, the pattern 32 can still be displayed. Pearlescent powder, glitter powder or luminous powder can also be added to the surface film layer 22 to make the pattern 32 have an iridescent effect, a metallic glitter effect or a luminous effect. The various effects mentioned above enhance aesthetic and visual experiences of the pattern 32.

In addition to the heat transfer material 10, the invention only needs to produce a small number of specifications of the covering film 20, that is, the surface film layer 22 with or without embossing, the surface film layer 22 coated with a zinc sulfide layer or a metal layer, or added with pearlescent powder, glitter powder or luminous powder can be provided, and the covering film 20 only needs to be manufactured in fewer styles. For manufacturers, products are not complicated and an inventory is in a small amount, which can reduce manufacturing costs and inventory costs, and meet requirements of environmental protection.

The method of the invention enables consumers to form the graphic and the pattern on a flexible sheet material by DIY while maintaining an integrity of the graphic and the pattern of the graphic. For manufacturers, the method of the invention is capable of significantly reducing product styles and reducing manufacturing and development costs.

Although the invention has been disclosed as above with the embodiments, they are not intended to limit the invention. A person having ordinary skill in the art to which the invention pertains can make various changes and modifications without departing from the spirit and scope of the invention. Therefore, a scope of protection of the invention shall be subject to what is defined in the pending claims.

What is claimed is

1. A method of forming a graphic on a flexible sheet material, comprising following steps of:
step 1, preparing a printable heat transfer material, the heat transfer material having a printing layer and a heat adhesive layer, printing a pattern on the printing layer of the heat transfer material;
step 2, preparing a covering film, the covering film comprising a transparent or translucent surface film layer and a second adhesive layer, adhering the covering film onto the printing layer of the heat transfer material through the second adhesive layer to cover the pattern;
step 3, cutting out a graphic from the adhered heat transfer material and the covering film that having the pattern, removing parts other than the graphic, keeping the cut graphic, the cut graphic comprising the laminated printing layer and the heat adhesive layer of the heat transfer material and the surface film layer and the second adhesive layer of the covering film; and
step 4, hot ironing the cut graphic onto a flexible sheet material, adhering the graphic onto the flexible sheet material with the heat adhesive layer, the surface film layer covering the cut graphic.

2. The method as claimed in claim 1, wherein the heat transfer material comprises a carrier layer; the printing layer and the heat adhesive layer are detachably disposed on the carrier layer.

3. The method as claimed in claim 1, wherein the covering film comprises a release layer, the surface film layer and the second adhesive layer are disposed on the release layer, and the surface film layer is located between the release layer and the second adhesive layer.

4. The method as claimed in claim 3, wherein one surface of the release layer is an embossed surface and is provided with a concave-convex texture; one surface of the surface film layer is in contact with the embossed surface, and the surface of the surface film layer is formed with a concave-convex texture.

5. The method as claimed in claim 1, wherein one surface of the surface film layer of the covering film is bonded with the second adhesive layer, and another surface of the surface film layer is a textured surface with a texture.

6. The method as claimed in claim 5, wherein a texture of the surface film layer is a concave-convex texture or a texture forming a laser effect.

7. The method as claimed in claim 1, wherein the covering film comprises a zinc sulfide layer bonded with one surface of the surface film layer.

8. The method as claimed in claim 1, wherein the covering film comprises a metal layer bonded with one surface of the surface film layer, and the metal layer does not cover the entire surface film layer.

9. The method as claimed in claim 1, wherein the surface film layer of the covering film is added with pearlescent powder, glitter powder or luminous powder.

10. The method as claimed in claim 1, wherein one surface of the surface film layer is provided with micro optical components, including: micro convex lenses, micro concave lenses, and micro convex or concave water droplet-shaped components.

11. The method as claimed in claim 1, wherein the surface film layer is a transparent or translucent reflective layer with reflective components.

12. The method as claimed in claim 1, wherein the step 4 of the method comprises: preparing a transfer film, transferring the cut graphic to the transfer film, applying a hot ironing process to the transfer film comprising the graphic on the flexible sheet material to bond the graphic onto the flexible sheet material, and removing the transfer film.

13. The method as claimed in claim 2, wherein a cutting depth of cutting out the graphic cuts off the surface film layer, the second adhesive layer, the printing layer and the heat adhesive layer; the second adhesive layer is a hot melt adhesive layer.

14. A method of forming a graphic on a flexible sheet material, comprising following steps of:
step 1, preparing a printable heat transfer material, the heat transfer material having a printing layer and a heat adhesive layer, printing a pattern on the printing layer of the heat transfer material;
step 2, cutting out a graphic from the heat transfer material with the pattern, removing parts other than the graphic;
step 3, hot ironing the cut graphic onto a flexible sheet material, adhering the graphic onto the flexible sheet material with the heat adhesive layer;
step 4, preparing a covering film, the covering film comprising a transparent or translucent surface film layer and a second adhesive layer, cutting out a graphic film being able to cover the graphic from the covering film; and
step 5, adhering the graphic film onto the graphic with the second adhesive layer, and the surface film layer of the graphic film covering the graphic.

15. The method as claimed in claim 14, wherein the heat transfer material comprises a carrier layer; the printing layer and the heat adhesive layer are detachably disposed on the carrier layer.

16. The method as claimed in claim 14, wherein the covering film comprises a release layer, the surface film layer and the second adhesive layer are disposed on the release layer, and the surface film layer is located between the release layer and the second adhesive layer.

17. The method as claimed in claim 16, wherein one surface of the release layer is an embossed surface and is provided with a concave-convex texture; one surface of the surface film layer is in contact with the embossed surface, and the surface of the surface film layer is formed with a concave-convex texture.

18. The method as claimed in claim 14, wherein one surface of the surface film layer of the covering film is bonded with the second adhesive layer, and another surface of the surface film layer is a textured surface with a texture.

19. The method as claimed in claim 18, wherein a texture of the surface film layer is a concave-convex texture or a texture forming a laser effect.

20. The method as claimed in claim 14, wherein the covering film comprises a zinc sulfide layer bonded with one surface of the surface film layer.

21. The method as claimed in claim 14, wherein the covering film comprises a metal layer bonded with one surface of the surface film layer, and the metal layer does not cover the entire surface film layer.

22. The method as claimed in claim 14, wherein the surface film layer of the covering film is added with pearlescent powder, glitter powder or luminous powder.

23. The method as claimed in claim 14, wherein one surface of the surface film layer is provided with micro optical components, including:
micro convex lenses, micro concave lenses, and micro convex or concave water droplet-shaped components.

24. The method as claimed in claim 14, wherein the surface film layer is a transparent or translucent reflective layer with reflective components.

25. The method as claimed in claim 14, wherein the step 3 of the method comprises: preparing a transfer film, transferring the cut graphic to the transfer film, applying a hot ironing process to the transfer film comprising the graphic on the flexible sheet material to bond the graphic onto the flexible sheet material, and removing the transfer film.

26. The method as claimed in claim 14, wherein in the step 2 of the method, a cutting depth of cutting out the graphic cuts off the printing layer and the heat adhesive layer; the second adhesive layer of the covering film is a hot melt adhesive layer; in the step 4, after cutting out the graphic film from the covering film, discarding parts other than the graphic film.
